(19) United States
(12) Patent Application Publication
(10) Pub. No.: US 2024/0417891 A1
(43) Pub. Date: Dec. 19, 2024

(54) SYSTEMS FOR DECOLORING AND RECYCLING PURE FIBERS

(71) Applicant: Looptworks Inc., Portland, OR (US)

(72) Inventors: Hoi Ting YIP, Hong Kong (CI); Sheng Yan LI, Hong Kong (CI); Patrick CHEUNG, Hong Kong (CI); Scott HAMLIN, Portland, OR (US)

(21) Appl. No.: 18/742,740

(22) Filed: Jun. 13, 2024

Related U.S. Application Data
(60) Provisional application No. 63/472,748, filed on Jun. 13, 2023.

(51) Int. Cl. D01G 11/00; D01F 2/24; D01F 6/62; D01G 5/00

(52) U.S. Cl. CPC D01G 11/00; D01F 2/24; D01F 6/62; D01G 5/00; D10B 2201/02; D10B 2331/04

(57) ABSTRACT

A system for recycling textiles includes a sorting module configured to automatically remove trims and to sort textiles into the fabric streams; a first decoloring system configured to receive the non-black and white cotton fabric stream and to provide a de-colored cotton fabric stream; a dry sanitization system configured to provide a sanitized cotton fabric stream and a sanitized polyester fabric stream; a second decoloring system configured to provide a semi de-colored cotton/polyester blend fabric stream; a fabric separation system configured to provide pure polyester fiber; a decoloring system configured to provide a de-colored polyester fabric stream; a cotton fiber recovery system configured to receive the de-colored or black or white and sanitized cotton fabric, and sanitized denim fabric streams; and a polyester fiber recovery system configured to receive the de-colored or black or white and sanitized polyester fabric streams.

### CROSS-REFERENCE TO PRIOR APPLICATIONS

The present application claims the benefit of priority to U.S. Provisional Application No. 63/472,748 filed Jun. 13, 2023, the entirety of which is incorporated herein by reference.

### BACKGROUND OF THE INVENTION

The present subject matter relates generally to fabric recycling treatment and processes. More specifically, the present invention relates to a fabric recycling system that produces hygienically clean, pure, and de-colored textile fibers from colored polyester or polyethylene terephthalate (PET), cotton/PET blend, cotton denim, and cotton textile waste.

Over the past 10 years, textiles have been the fastest growing waste stream in many countries. Unrecycled textiles cause significant waste disposal challenges as well as environmental problems. Despite these challenges, however, textile recycling practices remain largely ineffective outside of certain limited contexts.

Textile recycling processes vary based on the type of fabric being recycled. For example, the process of treating and recycling white cotton fabric is different than the process of treating and recycling a non-white cotton/polyester blend. The textile waste must be separated by fabric type prior to recycling. However, separation of textile waste into distinct waste streams can be problematic, and once separated, conventionally each waste stream must be processed separately, which can require shipping them to different facilities.

Textile waste generally falls into three categories: cut waste from factories, pre-consumer waste from brands, and post-consumer waste. Cut waste from factories can be easily divided into individual waste streams based on fabric type and color as the separation can be controlled at the source. In contrast, pre-consumer and post-consumer waste often involves a significant mixing of textiles of different fabric types and colors. Depending on the volume of mixed textiles to be sorted, the process of separating textiles can be impracticable or even impossible-it is time-consuming and can easily lead to improper placement of a fabric type in the wrong fabric stream. Mistakes in sorting pre-consumer and post-consumer fabrics can cause malfunction of machinery, leading to a damaged batch or recycled product.

In addition to sorting by material, qualified recycled fibers from particularly pre-consumer and post-consumer waste garments need to be adequately and hygienically cleaned and de-colored. Conventional methods of textile recycling cannot produce qualified hygienically clean, pure, and de-colored textile fibers from colored PET, cotton or cotton/PET blend pre- and post-consumer use. Additionally, under conventional recycling technologies, the user can only selectively recycle pure fiber or a single blended fiber content post-consumer textile into fibers. The waste from these conventional technologies therefore is significant.

Finally, conventional methods of textile recycling require different machinery to accommodate different fabric types, blends, and colors. Because post-consumer textile waste includes a large number of different fabric types, conventional methods require a number of separate processing lines. It can be impractical to use such a complex system to treat small volumes of recycled material and/or large streams of an individual fabric type, blend, or color.

Accordingly, there is a need for recycling apparatus, systems, and methods that can effectively process both pre- and post-consumer textile waste, including efficiently separating textile waste into individual fabric streams and process a plurality of such streams in order to recycle fibers from colored, pure, or blended PET and cotton textile waste having a high efficiency/utilization, as described herein.

### BRIEF SUMMARY OF THE INVENTION

To meet the needs described above and others, the present disclosure provides textile recycling systems and methods that recycle fibers from colored, pure, or blended PET and cotton textile waste into spinning yarns, nonwoven fibers, or cellulosic fibers. By controlling individual recycling processes within the recycling system, the individual processes can be tailored to achieve a higher utilization ratio, thereby producing sanitized, pure, color-sorted or color-removed PET and cotton fibers from pre-consumer and post-consumer textile waste. The textile recycling system of the present application can handle most PET and cotton waste recycling.

In one embodiment, the textile recycling system of the present application includes a textile pre-treatment phase, a textile treatment phase, and a fiber recovery and mechanical recycling phase. The textile pre-treatment phase includes a sorting subsystem that separates incoming textile waste into individual streams based on fabric type and coloring and includes a manual and/or automatic trims removal.

The textile treatment phase includes an individual treatment process for each individual fabric stream. For example, the textile treatment phase may include a cotton fabric treatment subsystem, a cotton denim fabric treatment subsystem, a polyester/cotton blended fabric subsystem, and a polyester fabric treatment subsystem. Depending on the condition of the textile, the fabrics may be directed to the fiber recovery and mechanical recycling phase without treatment. Still further, other blends such as wool or silk are directed to the fiber recovery and mechanical recycling phase without treatment.

In some embodiments, the textile treatment phase includes one or more of the following systems: a system for decoloring cotton fabric, a dry sanitization system, a system for decoloring cotton/polyester blended fabric, a hydrothermal separation system, and a system for decoloring polyester fabric.

In one embodiment of the present invention, a system for recycling textiles includes a sorting module or system configured to sort textiles into the following fabric streams:
a black cotton fabric stream;
a white cotton fabric stream;
a non-black and white cotton fabric stream;
denim cotton fabric streams, including dark navy, medium navy, light navy, and black;
a cotton/polyester blend fabric stream;
a black polyester fabric stream;
a white polyester fabric stream; and
a non-black and white polyester blend fabric stream.
   In other embodiments, fewer or greater numbers of individual streams may be provided.

The system also includes subsystems for specific treatment steps. For example, a first decoloring system receives the non-black and white cotton fabric stream and provides a de-colored cotton fabric stream. A dry sanitization system receives the black cotton fabric stream, the white cotton fabric stream, the denim cotton fabric stream, black polyester fabric stream, and the white polyester fabric stream and provides a sanitized cotton fabric stream and a sanitized polyester fabric stream. A second decoloring system receives the cotton/polyester blend fabric stream and provides a semi de-colored cotton/polyester blend fabric stream. A fabric separation system receives the semi de-colored cotton/polyester blend fabric stream from the second decoloring system and provides pure polyester fiber. A decoloring system receives the pure polyester fiber from the fabric separation system and the non-black and white polyester fabric stream and provides a de-colored polyester fabric stream.

In the final recycling phase, a cotton fiber recovery system receives the de-colored or black or white and sanitized cotton fabric, or sanitized denim fabric streams, and a polyester fiber recovery system receives the de-colored or black or white and sanitized polyester fabric streams. The cotton fiber and polyester fiber recovery systems produce pure recycled cotton and polyester fibers, respectively. Further, the components of the fiber recovery and mechanical recycling phase can be adjusted according to settings and controls that produce fibers having a length of between 1 and 2 in. or fibers having a length of less than 0.25 in.

In one embodiment, a textile recycling process includes a sorting module, one or more individualized treatment processes, and a mechanical recycling process. The sorting module is configured to receive incoming textiles and to sort the incoming textiles into individual fabric streams. The one or more individualized treatment processes are configured to receive an individual fabric stream and to produce a treated fabric stream. Each individualized treatment process includes one or more of the following subsystems: a decoloring system for cotton; a dry sanitization system for cotton; a decoloring system for polyester/cotton blends; a fiber separation system for polyester/cotton blends; and a decoloring system for polyester. The mechanical recycling process is configured to receive one or more treated fabric streams from the one or more individualized treatment processes and to produce recycled fibers of the respective treated fabric stream.

In another embodiment, a textile recycling system includes a sorting system, one or more individualized treatment systems, and a mechanical recycling system. The sorting system may include a manual sorting system and/or a garment sorting system, and is configured to receive incoming textiles and to sort the incoming textiles into individual fabric streams. Each individualized treatment systems is configured to receive an individual fabric stream and to produce a treated fabric stream, and includes one or more of the following subsystems: a decoloring system for cotton; a dry sanitization system for cotton; a decoloring system for polyester/cotton blends; a fiber separation system for polyester/cotton blends; and a decoloring system for polyester. The mechanical recycling system is configured to receive one or more treated fabric streams from the one or more individualized treatment systems and to produce recycled fibers of the respective treated fabric stream.

In a further embodiment, a textile recycling system includes a sorting module configured to receive incoming textiles and to sort the incoming textiles into individual fabric units stored in a storage; one or more individualized treatment processes, wherein each individualized treatment process is configured to receive an individual fabric stream from an individual fabric unit and to produce a treated fabric stream, a duct system including plurality of lengths of ducts, a controller, and a memory. The individualized treatment process includes one or more of the following subsystems: a decoloring system for cotton; a dry sanitization system for cotton; a decoloring system for polyester/cotton blends; a fiber separation system for polyester/cotton blends; and a decoloring system for polyester. Further, each length of duct extending between an individual fabric unit in the storage and one or more of each subsystem of the individualized treatment processes or between two subsystems of the individualized treatment processes. Each length of duct also includes a damper. The controller is in communication with the sorting module, the one or more subsystems of the one or more individualized treatment processes, and the duct system. The memory is in communication with the controller and is configured to store program instructions executable by the controller. In response to executing the program instructions, the controller is configured to: receive data indicating an amount of individual fabric streams in individual fabric units of the storage from the sorting module; identify one or more individualized treatment processes for the individual fabric streams, including the one or more subsystems for each individualized treatment process, the lengths of duct, and the dampers associated with the lengths of duct; modify settings of the one or more subsystems for each individualized treatment process based on the data of the individual fabric streams from the sorting module; operate the duct system to activate the one or more subsystems of each individualized treatment process; operate the duct system to close one or more dampers of the lengths of duct that are not part of the one or more identified individualized treatment processes; and control operation of one or more active dampers of the lengths of duct that are part of the one or more identified individualized treatment processes.

In further embodiments, the controller is further configured to receive user input identifying details related to the incoming textiles, and to modify the settings of the one or more subsystems for each individualized treatment process based on the user input.

In a still further embodiment, the textile recycling system further comprising mechanical recycling systems configured to receive the treated fabric streams and to produce recycled fibers. The controller is further configured to receive user input identifying recycled fiber requirements, and to modify settings of the mechanical recycling systems based on the user input.

An object of the invention is to provide an eco-friendly recycling treatment that includes automated fiber content and color sorting.

Another object of the invention is to provide a recycling system that includes a blend fiber content separation method, a fiber decoloring method, and a fiber recovery method.

An advantage of the invention is that the systems and methods process pure or blended, pre- and post-consumer polyester and cotton textile waste recycling.

Another advantage of the invention is that it enables the process parameters of each individual process to be optimized, thereby reducing textile waste.

A further advantage of the invention is that wastewater is minimized.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram of the textile recycling system of the present application.

FIG. 2 is a schematic diagram illustrated the process steps of the textile recycling system of the present application.

FIG. 3 is a schematic diagram illustrating a textile pre-treatment phase of the textile recycling system of FIG. 1.

FIG. 4 is a schematic diagram illustrating a cotton non-denim fabric treatment subsystem of the textile treatment phase of FIG. 1.

FIG. 5 is a schematic diagram illustrating a cotton denim fabric treatment subsystem of the textile treatment phase of FIG. 1.

FIG. 6 is a schematic diagram illustrating a polyester/cotton blend fabric treatment subsystem of the textile treatment phase of FIG. 1.

FIG. 7 is a schematic diagram illustrating a polyester fabric treatment subsystem of the textile treatment phase of FIG. 1.

### DETAILED DESCRIPTION OF THE INVENTION

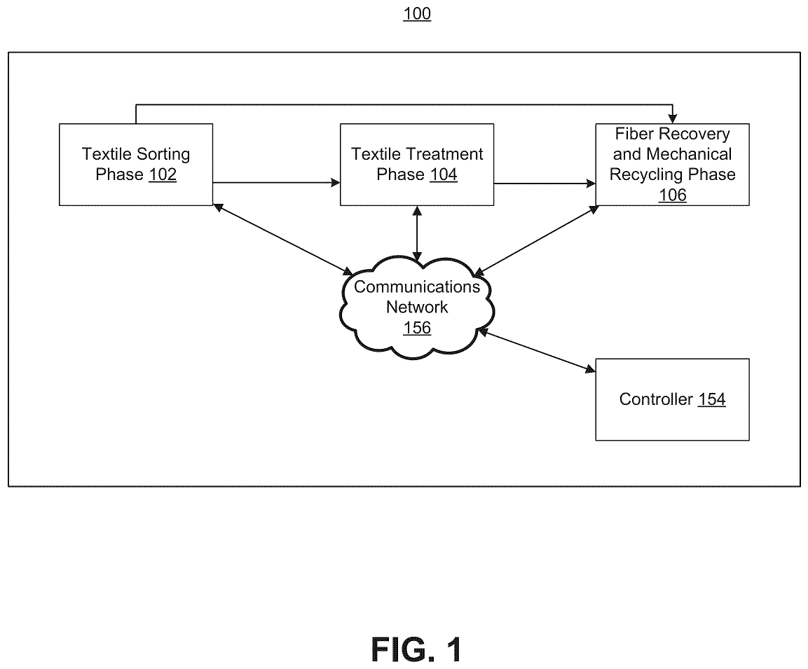

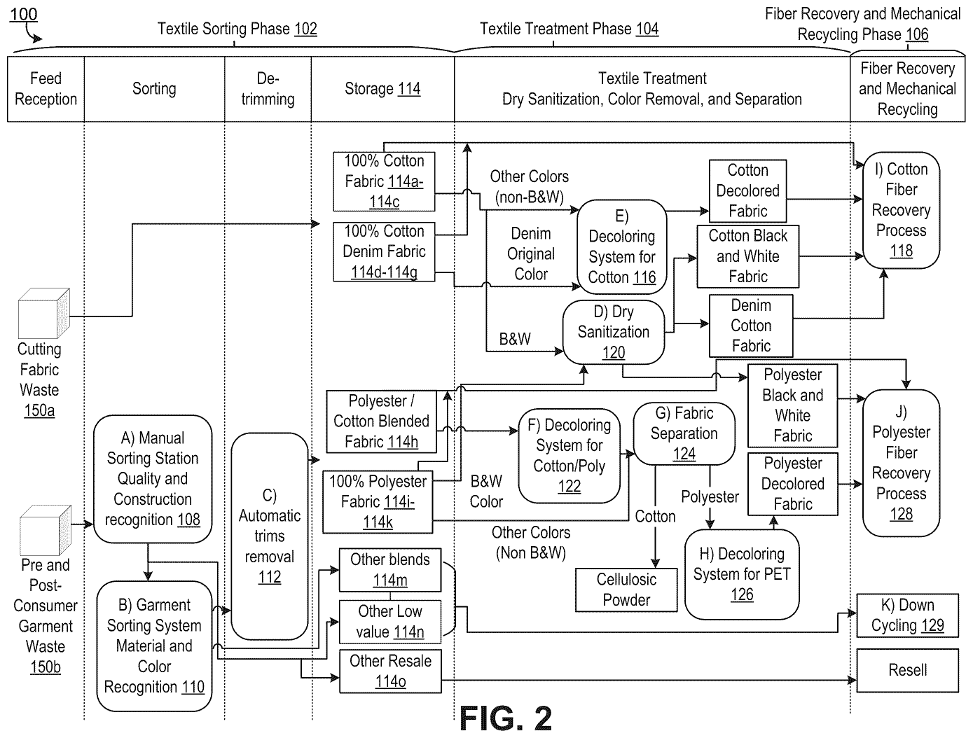

FIGS. 1-7 illustrate an example textile recycling system 100. As shown in FIGS. 1 and 2, the textile recycling system 100 includes three primary phases: a first phase of textile pre-treatment processes 102, a second phase of textile treatment 104, and a third phase of fiber recovery and mechanical recycling 106. The textile recycling system 100 also includes one or more controllers 154 that enable an administrator or operator to control the systems of each phase 102, 104, 106 as well as the duct system 158 through which textiles are transferred through the system 100. The textile recycling system 100 of the present application allows greater control over the individual treatment processes, allowing for both optimization of the system to accommodate specific starting materials and volumes as well as modification to the recycling phase 106 that enables control over final fiber length and quality.

Specifically, the present textile recycling system 100 enables the sorting of incoming textiles or starting materials into individual fabric streams based on fabric type, color, and/or any other distinguishing characteristic, the modification of settings of the individualized treatment processes to accommodate the specific fabric type, color, and volume of the starting materials, and the modification of settings of the individualized treatment processes as well as the fiber recovery and mechanical recycling processes to produce recycled fibers of a desired length. This flexible modularity is enabled by the duct system 158 and the control over components through the textile recycling system 100 described below.

Referring to FIG. 1, the textile pre-treatment processes 102, the textile treatment processes 104, and the fiber recovery and mechanical recycling phase 106 of the textile recycling system 100 communicate with one or more controllers 154 over a communications network 156. The communication links may be wired or wireless.

The one or more controllers 154 may be adapted to run a variety of application programs, access and store data, including accessing and storing data in the associated databases, and enable one or more interactions as described herein, including the execution of the methods and other features described above. Typically, the controller is implemented by one or more programmable data processing devices. The hardware elements, operating systems, and programming languages of such devices are conventional in nature, and it is presumed that those skilled in the art are adequately familiar therewith.

The one or more controllers 154 may be a central control processing system utilizing a central processing unit (CPU or processor), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions. The one or more controllers 154 may also include one or more input/output interfaces for communications with one or more processing systems. One or more such interfaces may enable communications via a network, e.g., to enable sending and receiving instructions electronically.

The one or more controllers 154 may further include appropriate input/output ports for interconnection with one or more output mechanisms (e.g., monitors, touchscreens, motion-sensing input devices, etc.) and one or more input mechanisms (e.g., keyboards, voice, touchscreens, bioelectric devices, magnetic readers, RFID readers, barcode readers, motion-sensing input devices, etc.) serving as one or more user interfaces for the controller 154.

Those skilled in the art will recognize that the one or more controllers 154 also encompasses systems such as host computers, servers, workstations, network terminals, and the like. Further, one or more controllers 154 may be embodied in a device, such as a mobile electronic device, like a smartphone or tablet computer. In fact, the use of the term controller 154 is intended to represent a broad category of components that are well known in the art. As such, it is recognized that the use of the term controller 154 may refer to a PC-type implementation communicating with the communications network 156 as shown in FIG. 1 or may be any one or more of the servers or resources, as will be understood by those skilled in the art based on the teachings provided herein.

Aspects of the systems and methods provided herein encompass hardware and software for controlling the relevant functions. Software may take the form of code or executable instructions for causing a controller 154 or other programmable equipment to perform the relevant steps, where the code or instructions are carried by or otherwise embodied in a medium readable by the controller 154 or other machines. Instructions or code for implementing such operations may be in the form of computer instruction in any form (e.g., source code, object code, interpreted code, etc.) stored in or carried by any tangible readable medium. As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a flexible disk, a hard disk, magnetic tape, any other magnetic medium, a CD-ROM, DVD, any other optical medium, a RAM, a PROM and EPROM, a FLASH-EPROM, any other memory chip or cartridge, or any other medium from which a controller can read programming code and/or data.

Referring to FIG. 2, use of the textile pre-treatment processes in the textile sorting phase 102 allows for greater control over the purity of the starting materials of the recycling system, which in turn results in a greater efficiency and recovery of useable product. The efficiency of automatic sorting is 1 second per garment per machine, while the manual process is around 4 second per garment per worker and is impossible if garments no longer contain correct content or care labels. Energy use is also optimized.

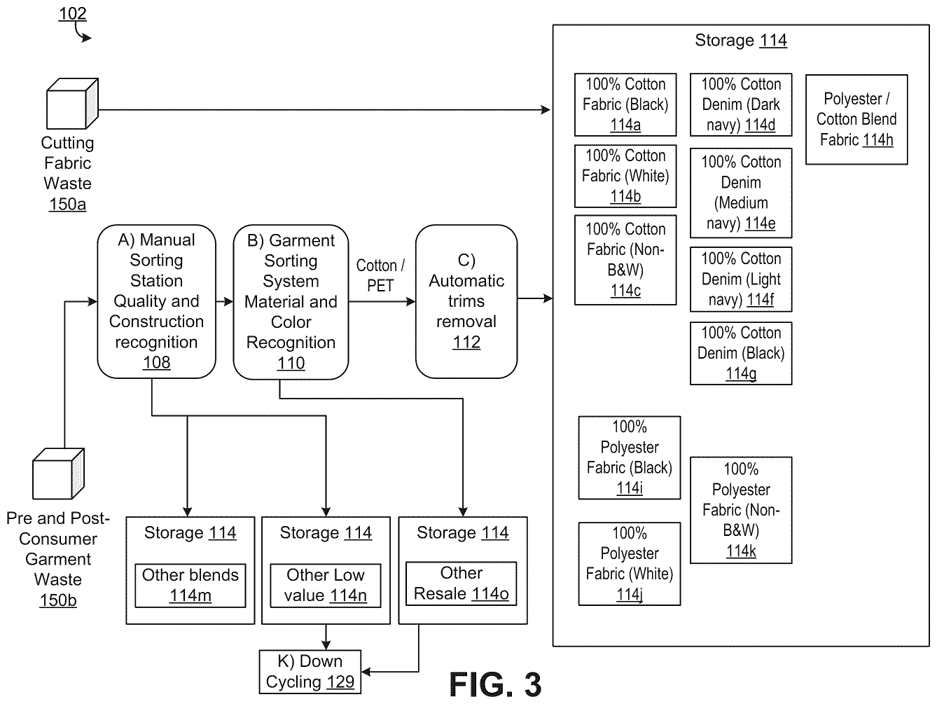

As shown in FIG. 3, the textile pre-treatment processes 102 begins with receiving and collecting input material 150 such as cutting fabric waste 150a and pre- and post-consumer garment waste 150b. The input material 150 may include all garment types of cellulose, polyester, nylon material, etc. including deadstock from retailers and post-consumer garments, such as tee shirts, sweatshirts, jeans, sweaters, tops, pants, aprons, bedding, raw materials, etc.

The cutting fabric waste 150a generally refers to discarded textile materials from a textile manufacturing facility. Because these fabrics 150a are typically captured in large quantities of the same material, manual sorting is unnecessary. Cutting fabric waste 150a is typically directed to textile storage 114. If sorting is necessary, the cutting fabric 150a may be directed to the manual sorting station 108.

The pre- and post-consumer garment waste stream 150b generally includes discarded clothing, bedding, curtains, or other garments. Garment waste 150b is directed to a manual sorting station 108, where low-value and other re-sale garments are removed. Manual sorting of the garment waste 150b may include quality recognition and sorting by garment color and fabric type. The low-value garment waste streams 114n, 114m are removed from the pre- and post-consumer garment waste stream 150b and are directed to a down-cycling process 129, which is part of the third phase of fiber recovery and mechanical recycling 106.

The manually-sorted pre- and post-consumer garment waste stream 150b is then directed to an automatic garment sorting station 110 that separates the garment waste stream 150b into cotton garment, PET garment, and other blended garment waste streams. For example, optical sorting technologies, such as but not limited to Fibersort® garment sorting, may be used to automate industrial scale textile fiber and color sorting. In one embodiment, the garment waste stream 150b may be separated into substrate categories of 100% cotton, 100% polyester, and cotton/polyester blends. Within those substrate categories, the individual streams may be further separated based on color, including black, white, non-black and white, black denim, dark navy denim, medium navy denim, and light navy denim. The other blended fabric waste streams are directed to the textile storage 114 and subsequently directed to a down cycling process 129, which is part of the third phase of fiber recovery and mechanical recycling 106. Some fabric textiles may be directed to the textile storage 114 and subsequently sent directly for resale.

The cotton and PET garment streams are then directed to a processing station 112 for trims removal. The processing station 112 may include a manual component and/or an automatic trims removal process such as a robotic artificial intelligence-driven process for removing zippers, buttons, snaps, and seams that are difficult to process as well as care labels, tags, and other attachments. Once the trims have been removed, the individual cotton and PET fabric waste streams are directed to the textile storage 114.

In one embodiment, the individual cotton, PET, and cotton/PET blended fabric streams are stored in units at the textile storage 114 based on material substrate and color. The high level of sorting allows the textile recycling system 100 to appropriately treat fabric streams as needed to produce pure fibers. In the illustrated embodiment, the textiles are separated into the following individual fabric storage units 114a-114o:
100% black cotton fabric unit 114a, including only black fabric made of 100% cotton;
100% white cotton fabric unit 114b, including only white fabric made of 100% cotton;
100% non-black and white cotton fabric unit 114c, including all non-white and non-black fabric made of 100% cotton;
100% black cotton denim fabric unit 114d, including black denim fabric made of 100% cotton;
100% dark navy cotton denim fabric unit 114e, including dark navy denim fabric made of 100% cotton;
100% medium navy cotton denim fabric unit 114f, including medium navy denim fabric made of 100% cotton;
100% light navy cotton denim fabric unit 114g, including light navy denim fabric made of 100% cotton;
100% polyester/cotton blend fabric unit 114h, including all fabric made of polyester/cotton blends;
100% black polyester fabric unit 114i, including only black fabric made of 100% polyester;
100% white polyester fabric unit 114j, including only white fabric made of 100% polyester;
100% non-black and white polyester fabric unit 114k, including all non-white and non-black fabric made of 100% polyester;
Other resale unit 114m, including other fabrics that cannot be recycled into fibers or downcycled that are eligible for resale without treatment;
Other low value unit 114n, including other fabrics that cannot be recycled into fibers that are suitable for downcycling; and
Other blends 114o, including other fabrics of blended materials that cannot be recycled into fibers that are suitable for downcycling.

In some examples, the individual fabric streams above are categorized according to color, such as “black” and “white.” In some instances, “black” refers to only true black garments, whereas in other instances, a dark gray may qualify as “black.” In some instances, the fabric type may impact whether a “dark gray” garment falls into the “black” category. Further, “white” garments may include whites ranging from bright white to off white. In some examples, the dark, medium, and light navy denim color ranges include solid indigo with no fade, classic blue jean with some fade, and light denim with a majority fade, respectively. Finally, the polyester/cotton blend can include any balance of cotton and polyester material.

While the units above indicate streams of 100% of a fabric type, it is understood that in some instances, the units 114 may include a slight variation or a small amount of unmatching fabric.

By providing a sequence of modules to accommodate sorting of highly mixed post-consumer textile waste, the textile recycling system 100 is flexible and adaptable to efficiently sort large volume of mixed textile waste prior to recycling.

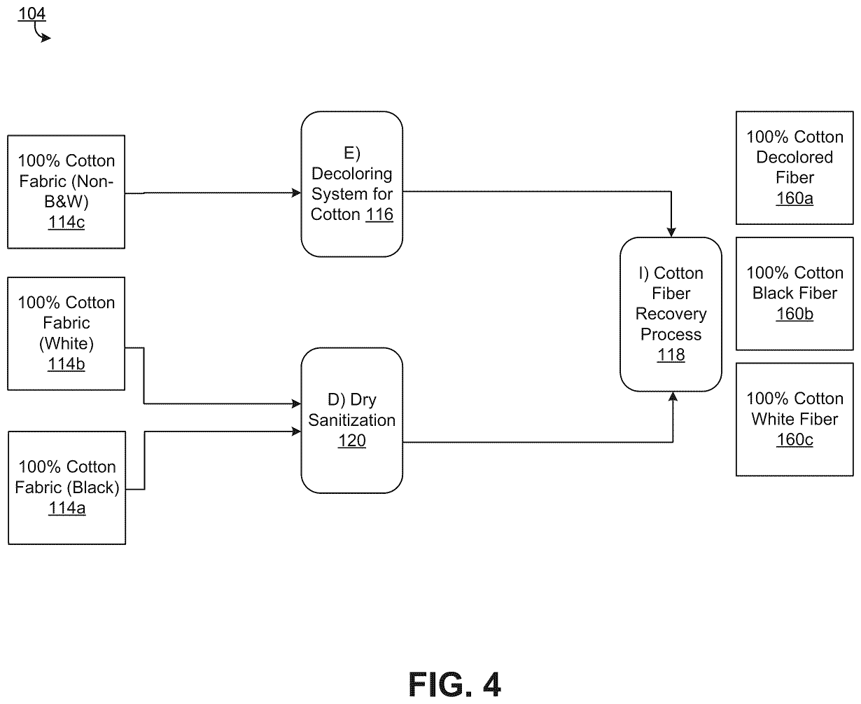

Referring back to FIG. 2, the second phase 104 of the textile recycling system 100 includes individualized treatment processes of each individual fabric stream 114a-114k in the textile storage 114 as shown in FIGS. 4-7. Specifically, each individualized treatment process includes one or more specific method of treatment such as a dry sanitization system 120, a decoloring system 116 for cotton, a decoloring system 122 for cotton/polyester blends, a separation system 124 for cotton/polyester blends, and a decoloring system 126 for polyester. Additionally, the different systems 116, 120, 122, 124, 126 may be connected to more than one fabric unit 114a-114k, i.e., may be shared between individualized treatment processes, as described below.

Individual fabric storage units 114a-114k within the textile storage 114 are interconnected to the relevant treatment systems 116, 120, 122, 124, 126 through a duct system 158 that utilizes airflow to move textiles from one location to another. Each length of duct between individual components, referred to as duct lengths, includes one or more dampers or other mechanical structures that control the opening or closing of the duct length. While FIGS. 2-7 schematically shows the duct system 158 process flow, it should be understood that each length of duct of the duct system 158 is not shown.

The controller 154 of the textile recycling system 100 enables an administrator or operator to easily control the settings and controls of the machinery of each phase 102, 104, 106, including each treatment system 116, 120, 122, 124, 126, as well as the duct system interconnecting the components. For example, based on the type and volume of starting materials, the textile recycling system 100 can optimize the settings of the treatment systems 116, 120, 122, 124, 126 of the textile treatment phase 104 in order to shut off systems that are not needed and to adjust the necessary systems appropriately to accommodate the starting material type and volume. In one example, if the starting materials include only cotton and polyester blended fabrics, the operator can adjust the settings at the controller to shut off the dry sanitization system 120, the decoloring system 116 for cotton, and the decoloring system 126 for PET.

For example, the controller may be configured to receive information and adjust the individual treatment processes and systems and/or the fiber recovery and mechanical recycling processes and systems accordingly. The information may include one or more of the following: user input related to the incoming textile or starting materials, data from the sorting module or system including details related to the individual fabric streams in individual fabric units of the storage, user input including a desired profile or characteristic of the recycled fibers produced by the fiber recovery and mechanical recycling processes and systems. The controller may effectuate these adjustments by modifying the settings of the one or more subsystems for each individualized treatment process and/or the mechanical recycling systems based on the information. In other embodiments, the controller is configured to receive additional information.

The controller may also be configured to operate the duct system 158 in accordance with the individual treatment processes and systems as adjusted and/or identified. For example, the controller may be configured to activate the one or more subsystems of each individualized treatment process, and/or operate the duct system to close one or more dampers of the lengths of duct that are not part of the one or more identified individualized treatment processes. The controller may also be configured to control operation of one or more dampers of the lengths of duct that are part of the one or more identified individualized treatment processes. In still further embodiments, the controller may be configured to receive additional information, identify components, and operate additional aspects of the textile recycling system 100. In further embodiments, the textile recycling system 100 optimizes the duct system 158 in order to improve efficiency and reduce energy costs.

The textile recycling system 100 can also optimize the settings of the relevant treatment systems 116, 120, 122, 124, 126 and the cotton and polyester fiber recovery processes 118, 128 in order to produce the desired length of recycled fibers of the end product.

In another example, the components of the textile recycling system 100 can be specified through user settings and controls to not only select the desired treatment systems 116, 120, 122, 124, 126, but also to control the sequence of the selected components within an individualized treatment process. While FIGS. 2-7 illustrate generally linear treatment processes, it should be understood that the combinations and ordering of the treatment systems 116, 120, 122, 124, 126 may vary from the illustrated embodiment and further that the duct system enables the treatment systems 116, 120, 122, 124, 126 to operate in any combination and order as desired or as required by the individual fabric stream, the desired characteristics of the recycled fibers to be produced from the individual fabric stream, or any other factors. For example, the operator may operate a first individualized treatment process that utilizes the fabric separation system 124 first followed by the decoloring system 126, and then operate a second individualized treatment process that utilizes the decoloring system 126 first followed by the fabric separation system 124.

As shown in FIGS. 2 and 4-7, the individualized treatment processes are based on fabric type and color. Generally, each of the dry sanitization system 120, the decoloring system 116 for cotton, the decoloring system 122 for cotton/polyester blends, the separation system 124, and the decoloring system 126 for PET generates little to no wastewater. In one embodiment, the fiber recovery and mechanical recycling phase 106 utilizes a closed loop wastewater system to filter and treat wastewater before discharge. Further, the closed loop captures any solids in the wastewater from the recycling phase 106 for returning to the textile storage 114 for recycling.

Referring to the embodiment illustrated in FIGS. 2, 4, and 6, the decoloring systems 116, 122 for cotton or cotton/polyester blend fabric is a dry system that does not use water to remove cotton color from the cotton and polyester/cotton blend. The system is suitable for most cotton products, including reactive dye, indigo dye, and direct dye, and removes more than 90% of the color. In some embodiments, the decoloring system process time is approximately 30-180 minutes. In alternative embodiments, a decoloring system such as but not limited to a bleach-based decoloring system may be used. The dry sanitization system 120 is used to remove bacteria and fungi from the black, white, and denim cotton fabrics and the black and white polyester fabrics. In some example processes, dry sanitization using the EN 1174 test method results in a >90% micro-organism reduction. Non-limiting exemplary dry sanitization systems 120 utilize ozone-based sanitization processes, ultraviolet light-based sanitization processes, or other suitable dry sanitization processes. In some embodiments, the dry sanitization process time is approximately 10 to 75 minutes. In still further embodiments, a bleach-based system may be used in lieu of the dry sanitization system 120.

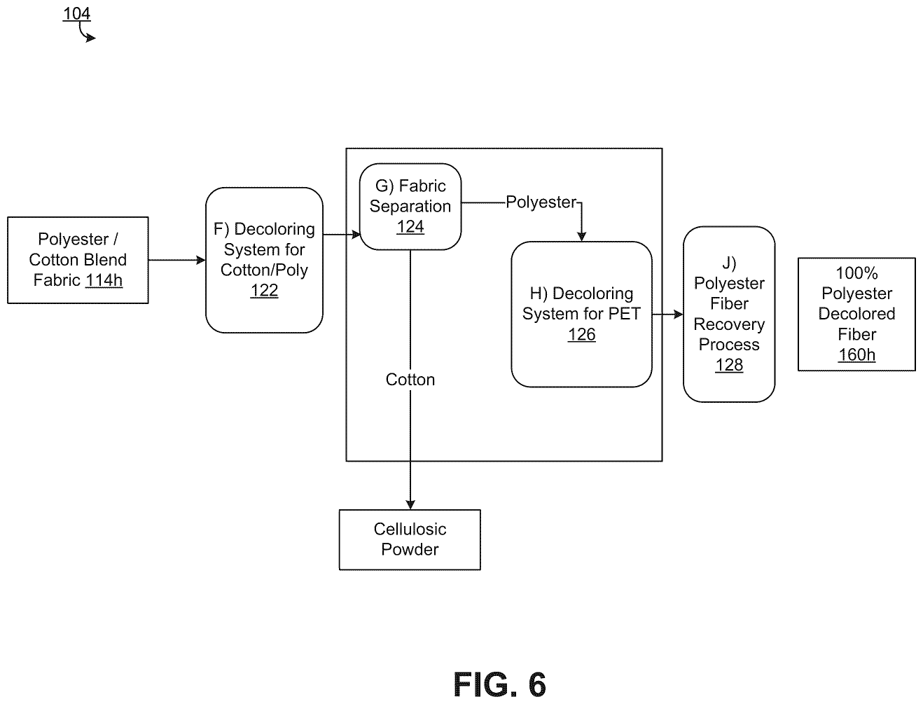

FIGS. 2 and 6 include a fiber separation system 124 to separate cotton and polyester blends. In one embodiment, the fiber separation system 124 uses only heat, water, and less than 0.5-10% by weight of biodegradable green chemicals. U.S. Pat. No. 11,396,114, incorporated herein by reference, discloses the methods for separating and recycling polyester/cotton textiles by means of a hydrothermal reaction catalyzed by an organic acid, and is incorporated by reference. This hydrothermal separation process achieves a recovery rate of over 95% for polyester fibers in about 0.5 hr to 3 hrs. In other embodiments, the fiber separation system 124 may include any other suitable separation system such as, but not limited to, glycolysis, methanolysis, and hydrolysis.

In one embodiment, the decoloring system 126 for PET utilizes heat, water, and commercial activated carbon to remove color. Activated carbon is used as dye adsorbents and may be treated as normal solid waste. U.S. Pat. No. 11,085,148, incorporated herein by reference, discloses methods for decolorizing textile materials under hydrothermal conditions using dye adsorbent materials, and is incorporated by reference. The activated carbon systems achieve more than 95% color removal. In some embodiments, the chemical process time is approximately about 0.5 hr to 8 hrs. In other embodiments, the decoloring system 126 may utilize means other than activated carbon to remove color from polyester fabric such as, but not limited to, a bleach-based decoloring process.

FIGS. 4-7 illustrate the treatment processes of each individual fabric stream of the second phase 104 as well as the fiber recovery and mechanical recycling per individual fabric stream of the third phase 106. It is understood that while single discharge lines from certain systems 120 are shown in the FIGS. 4-7, it is understood that the individual treatment processes remain individualized throughout the textile treatment phase 104 and the fiber recovery and mechanical recycling phase 106 to produce a final product of fibers of a singular fabric type and color. For example, the individual fabrics 114a-114k may use the same treatment system 116, 120, 122, 124, 126, but any plurality of fabric streams 114 use the same treatment system 116, 120, 122, 124, 126 at different times to maintain separation of fibers, meaning the individualized fabric streams. In some embodiments, however, it may be desired to combine individual fabric streams. Such combination can be accomplished through user input provided to the controller 154 to control the duct system.

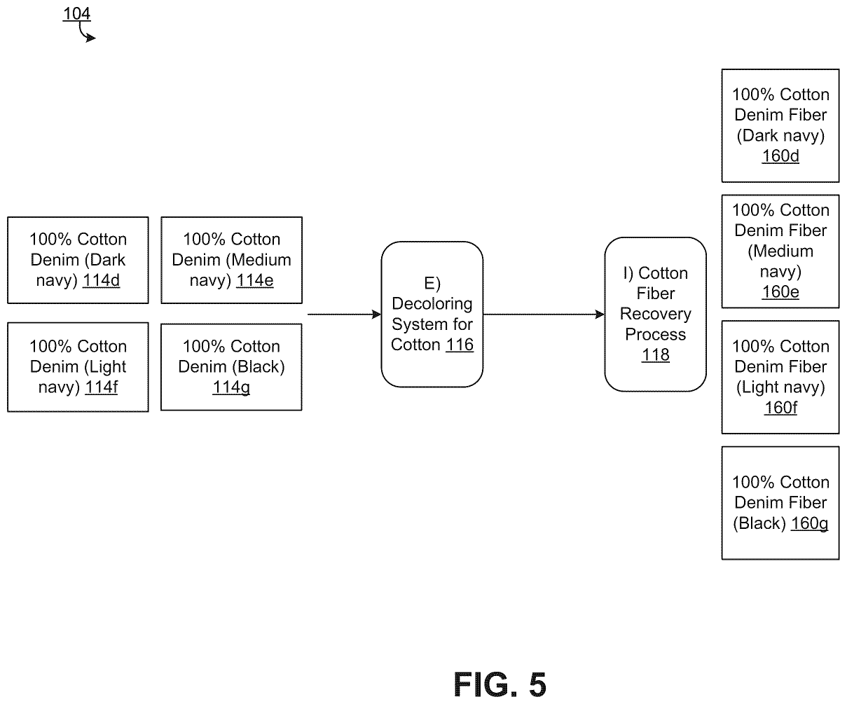

FIGS. 4 and 5 illustrate the treatment processes for cotton fabrics 114a-114c. Referring to FIG. 4, non-black and white cotton fabric 114c from the textile storage 114 is directed to the first decoloring system 116 for cotton, which provides a decolored fabric stream which is then directed to a cotton recovery system 118. Black cotton fabric and white cotton fabric 114a, 114b are directed to the dry sanitization system 120, which provides a sanitized cotton fabric stream, which is then directed to the cotton recovery system 118. The denim cotton fabrics are also directed to the dry sanitization system 120 and then subsequently to the cotton recovery system 118 as shown in FIG. 5.

As shown in FIG. 6, the polyester/cotton blend fabric 114d is first processed in the second decoloring system 122 for cotton/polyester to provide a semi-decolored cotton/polyester fabric stream, which is then directed to the fiber separation system 124 to chemically separate the cotton from the polyester. The pure polyester or PET fibers from the fiber separation system 124 are then directed to the decoloring system 126 for PET, which produces a decolored polyester fiber. The decolored polyester fiber is then directed to a polyester fiber recovery system 128. In the fiber separation system 124, the cotton fibers are converted into cellulose powder for use in other applications.

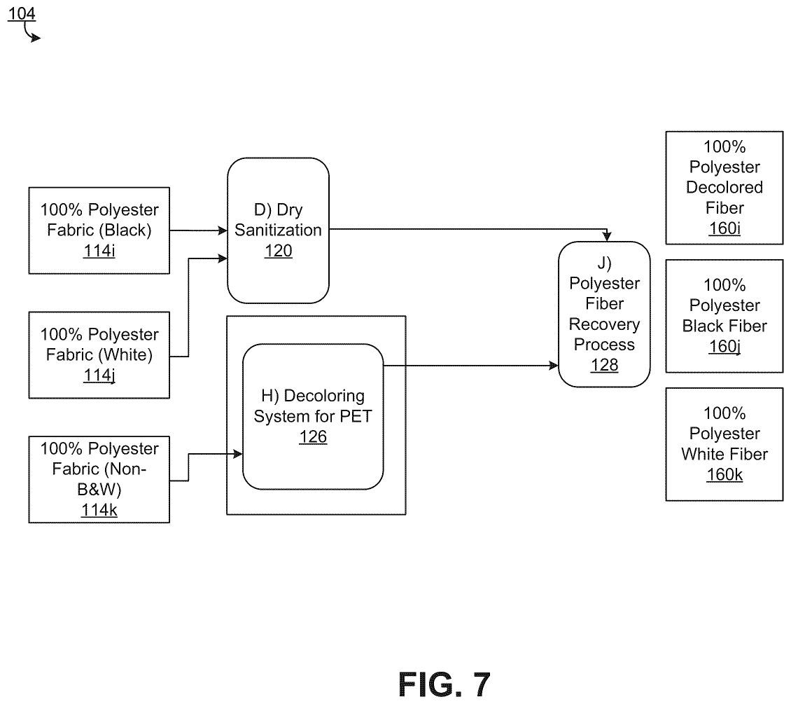

The treatment processes for the 100% polyester fabric streams are shown in FIG. 7. In some embodiments, the 100% black polyester fabric and white polyester fabric are first directed to the dry sanitization system 120, which provides a sanitized polyester fabric stream that is then directed to the polyester fiber recovery system 128. In other embodiments, the 100% black polyester fabric and white polyester fabric are sent directly to the polyester fiber recovery system 128. The non-black and white polyester fabric is processed by the decoloring system 126 for PET, producing a de-colored polyester fabric stream that is directed to the polyester fiber recovery system 128.

The third phase 106 of fiber recovery and mechanical recycling includes the cotton fiber recovery system 118 and the polyester recovery system 128 shown in FIGS. 2 and 4-7. The fiber recovery and mechanical recycling systems 118, 128 of textiles and apparel into fibers for spinning do not use hazardous chemicals and minimizes or eliminates waste. In some embodiments, cotton is processed in a first production line and polyester is processed in a second production line. Processed fiber can be stored in units 160a-160k and/or can be pressed to bale. In some embodiments, the fiber recovery and mechanical recycling process time is 1-60 minutes.

As noted above, the fiber recovery and mechanical recycling phase 106 may be controlled in order to produce fibers of a specific length. For example, in the fiber recovery processes 118, 128, the treated fabrics are opened and cut to a specific length. Generally, the fiber lengths are about 0.25 in. In some embodiments, the operator of the textile recycling system 100 can modify the settings associated with the individualized treatment processes and components 104 and the mechanical recovery phase 106 through the computer 124 to produce recycled fibers having lengths of 1 to 2 in.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A textile recycling process comprising:
a sorting module configured to receive incoming textiles and to sort the incoming textiles into individual fabric streams;
one or more individualized treatment processes, wherein each individualized treatment process is configured to receive an individual fabric stream and to produce a treated fabric stream, and wherein each individualized treatment process includes one or more of the following subsystems:
a decoloring system for cotton;
a dry sanitization system for cotton;
a decoloring system for polyester/cotton blends;
a fiber separation system for polyester/cotton blends; and
a decoloring system for polyester; and
a mechanical recycling process configured to receive one or more treated fabric streams from the one or more individualized treatment processes and to produce recycled fibers of the respective treated fabric stream.

2. The textile recycling system of claim 1, wherein the sorting module includes a manual sorting system and a garment sorting system.

3. The textile recycling system of claim 2, wherein manual sorting system separates low-value garments and blends from the incoming textiles.

4. The textile recycling system of claim 2, wherein the garment sorting system separates the incoming textiles by textile type, color, and blend.

5. The textile recycling system of claim 2, wherein the sorting module further includes an automatic trims removal system.

6. The textile recycling system of claim 1, wherein the individual fabric streams include a cotton stream, a polyester stream, and a cotton/polyester blend stream.

7. The textile recycling system of claim 6, wherein the individual fabric streams include a black cotton stream, a white cotton stream, a non-black and white cotton stream, a denim cotton stream, a black polyester stream, a white polyester stream, a non-black and white polyester stream, and a polyester/cotton blend stream.

8. The textile recycling system of claim 7, wherein the denim cotton stream includes a black denim cotton stream, a dark navy denim cotton stream, a medium navy denim cotton stream, and a light navy denim cotton stream.

9. The textile recycling system of claim 6, wherein the individual treatment process for the black cotton stream and the white cotton stream includes the dry sanitization system for cotton.

10. The textile recycling system of claim 6, wherein the individual treatment process for the non-black and white cotton stream includes the decoloring system for cotton.

11. The textile recycling system of claim 6, wherein the individual treatment process for the polyester/cotton blend stream includes the decoloring system for cotton/polyester blends, the fiber separation system, and the decoloring system for polyester.

12. The textile recycling system of claim 6, wherein the individual treatment process for the black polyester stream and the white polyester streams includes the dry sanitization system.

13. The textile recycling system of claim 6, wherein the individual treatment process for the black polyester stream and the white polyester streams includes the dry sanitization system.

14. The textile recycling system of claim 1, further comprising a storage configured for storing individual fabric streams in individual units, the textile recycling system further comprising a duct system including a plurality of lengths of ducts, each length of duct extending between an individual fabric unit in the storage and one or more of each subsystem of the individualized treatment processes.

15. The textile recycling system of claim 1, wherein the recycled fibers have a length of about 1to about 2 in.

16. A textile recycling system comprising:
a sorting module configured to receive incoming textiles and to sort the incoming textiles into individual fabric units stored in a storage;
one or more individualized treatment processes, wherein each individualized treatment process is configured to receive an individual fabric stream from an individual fabric unit and to produce a treated fabric stream, and wherein the individualized treatment process includes one or more of the following subsystems:
a decoloring system for cotton;
a dry sanitization system for cotton;
a decoloring system for polyester/cotton blends;
a fiber separation system for polyester/cotton blends; and
a decoloring system for polyester;
a duct system including a plurality of lengths of ducts, each length of duct extending between an individual fabric unit in the storage and one or more of each subsystem of the individualized treatment processes or between two subsystems of the individualized treatment processes, wherein each length of duct includes a damper;
a controller in communication with the sorting module, the one or more subsystems of the one or more individualized treatment processes, and the duct system;
a memory in communication with the controller, wherein the memory is configured to store program instructions executable by the controller, wherein, in response to executing the program instructions, the controller is configured to:
receive data indicating an amount of individual fabric streams in individual fabric units of the storage from the sorting module;
identify one or more individualized treatment processes for the individual fabric streams and the associated one or more subsystems for each individualized treatment process;
modify settings of the one or more subsystems for each individualized treatment process based on the data of the individual fabric streams from the sorting module;
operate the duct system to activate the one or more subsystems of each individualized treatment process;
operate the duct system to close one or more dampers of the lengths of duct that are not part of the one or more identified individualized treatment processes; and
control operation of one or more active dampers of the lengths of duct that are part of the one or more identified individualized treatment processes.

17. The textile recycling system of claim 15, wherein the controller is further configured to:
receive user input identifying details related to the incoming textiles;
modify the settings of the one or more subsystems for each individualized treatment process based on the user input.

18. The textile recycling system of claim 15, further comprising mechanical recycling systems configured to receive the treated fabric streams and to produce recycled fibers, and wherein the controller is further configured to:
receive user input identifying recycled fiber requirements;
modify settings of the mechanical recycling systems based on the user input.
